(19) United States
(12) Patent Application Publication
(10) Pub. No.: US 2016/0381479 A1
(43) Pub. Date: Dec. 29, 2016

(54) Method for controlling a wireless audio receiver unit and wireless audio receiver unit

(71) Applicant: Sennheiser electronic GmbH & Co. KG, Wedemark (DE)

(72) Inventors: MARKUS THIELE, Hannover (DE); Dela Bahlke, Hannover (DE); Sven Wachtendorf, Wedemark (DE); Johannes Tieck, Hannover (DE)

(73) Assignee: Sennheiser electronic GmbH & Co. KG, Wedemark (DE)

(21) Appl. No.: 15/094,138

(22) Filed: Apr. 8, 2016

(30) Foreign Application Priority Data
Apr. 10, 2015 (DE) 102015206418.2

(51) Int. Cl. H04R 29/00; G06F 1/32; G06F 1/26

(52) U.S. Cl. CPC H04R 29/004; G06F 1/266; G06F 1/3296; H04R 2420/09

(57) ABSTRACT

There is provided a method which makes it possible for a device connected to an electronic video camera to be put into a sleep mode by way of switching off the phantom voltage at the interface for sound and to put it back into the working mode again when the phantom voltage from same reappears. In that case that device can put further devices into a sleep mode by way of a wireless connection and also switch them back into the normal working mode again.

The present application claims priority from German Patent Application No. 10 2015 206 418.2 filed on Apr. 10, 2015, the disclosure of which is incorporated herein by reference in its entirety.

### FIELD OF THE INVENTION

It is noted that citation or identification of any document in this application is not an admission that such document is available as prior art to the present invention.

The present invention concerns a method of controlling a wireless audio receiving unit and a wireless audio receiving unit.

The production of television news broadcasts is nowadays generally implemented by collecting individual scenes (takes) and then putting them together before the broadcast. In that situation those individual scenes are typically either produced in the television studio or “on site”, that is to say directly at the place where the action occurs. For that purpose mobile recording teams are usually set up, which for cost reasons often only consist of two people, namely that person who is responsible for images with a mobile video camera and a further person responsible for sound, insofar the team for example itself directly goes to close to the location of the action and comments on the event themselves or interviews a third person. In that case nowadays in such situations the video and audio signals are almost exclusively recorded together in the video camera. In that way, in contrast to separate recording which was earlier usual (so-called dual-band process) the later operation of synchronously bringing the two recordings together is redundant. The video camera records both signals synchronously at the same time. Among news journalists the terms VJ (=video jockey or video journalist) and ENG (=electronic news gathering) have become the current usage for that process.

In such scenarios it has proven effective for the filming person to position himself in such a way that the person responsible for sound is also to be seen in the video image. That usually requires a certain spatial distance between them. In order in that respect to avoid the difficulty caused by a cable connection between camera and microphone nowadays radio microphones are almost exclusively employed. A somewhat different situation arises in cases where the person responsible for sound cannot go directly to the location where the action occurs, for example because he would already be in mortal danger there. That can be the case for example in regard to catastrophes or monumental natural events (volcano erupting). As the television viewer expects associated sound even in that case directional microphones for example are used, which record both the sound event of the scene being filmed and also possibly commentaries from people. In those cases however the sound event itself is also generally transmitted wirelessly to the camera which then jointly records video and audio signals.

Some of those microphones require an auxiliary voltage which nowadays is made available by practically all mobile professional video cameras. The so-called (P48) phantom power has prevailed for that purpose, which is provided at the microphone input of the camera generally at an XLR plug. The digits 48 in that case denote the nominal voltage of 48 volts; that has almost completely prevailed in regard to outside use.

Nowadays very small wireless receivers are available on the market for such situations involving wireless transmission. They can be fixed directly to the audio input plug of the camera. So that they do not stress the battery of the camera and because otherwise a plug connection would have to be provided by the camera, which supplies the receiver with power, the receiver has its own power supply in the form of batteries. They can be either rechargeable batteries (accumulators) or also primary cells. The radio microphone transmitting to the wireless receiver is typically also equipped with a battery (accumulator or primary cell).

The deployments of such mobile teams often involves a certain hustle and bustle as very often they are sent off at short notice and often have to capture the latest news—sometimes in a dangerous environment with great urgency. In that case it can easily happen that certain things are overlooked. Thus for example it repeatedly happens that, when using wireless microphones, the team members forget to switch off the battery-powered receivers and/or the also battery-powered associated sound transmitter (often a wireless microphone). The result of this is that those batteries are (partially) discharged at the next use or in the worst-case scenario during the next transmission can provide too little power for further operation so that there can even be a short interruption in the transmission of sound. Admittedly the teams sensibly have a suitable number of reserve accumulators, but the number thereof (and thus the total weight of the equipment which is taken along) can be reduced if it is possible to ensure the teams do not forget to switch off the equipment, by mistake.

In the German patent application from which priority is claimed the German Patent and Trade Mark Office searched the following documents: U.S. Pat. No. 7,046,815 B2 and US 2008/0187141 A1.

### SUMMARY OF THE INVENTION

An object of the present invention is to provide a method of controlling a wireless audio receiving which avoids or reduces inadvertently forgetting to shut down the audio receiving unit. In particular an object of the present invention is to improve the function of the receiving unit, in particular preventing unnecessary consumption of battery power.

Thus there is provided a method of controlling a wireless audio receiving unit. The wireless audio receiving unit has a plug for the output of wirelessly received audio signals. The plug of the wireless audio signal receiving unit is placed in a jack of a device, which provides a phantom voltage or an external feed at the jack. The phantom voltage or the external feed at the jack is monitored. A power-saving sleep mode of the wireless audio receiving unit is activated when no phantom voltage or external feed occurs at the plug. A working mode of the wireless audio receiving unit is activated when the phantom voltage or the external feed is applied again.

When the camera is switched off the phantom voltage (of typically 48 volts) goes back to zero. That is detected by the connected wireless receiving unit for the audio signals. The receiving unit uses that information to put itself into a power-saving operating mode in which however it can still completely resume its function again due to the phantom voltage reappearing.

The decrease in the phantom feed typically does not take place very rapidly as it only permits a low level of current carrying capacity (insofar as it is designed in accordance with one of the standards relating thereto). In addition that phantom voltage should be extremely low-noise for example when operating capacitor microphones. It is therefore filtered very greatly in the feeding device (in this case the camera). The consequence of this is that when the camera is switched off the voltage collapses possibly only in the time range of seconds (all the more so if no current consumer is connected). Care is therefore to be taken to ensure that the connected device (for example the wireless receiver) is capable of detecting that slow process in error-free fashion. Whether it can sense that the camera is switched off because of the slowly falling phantom voltage somewhat earlier or later is in contrast of secondary importance.

As the consumed power of a wireless audio receiving unit is sufficiently low in the sleep mode that can be used to entirely dispense with switching off the device. As moreover those devices automatically revert to the working mode again when the phantom voltage reappears there is also no need for them to be explicitly switched on for (renewed) launching. That results in reliable operation and a gain in convenience.

In accordance with a further aspect of the invention moreover when the phantom voltage disappears the wireless receiver can beforehand also put the device sending it the audio signal (typical a wireless microphone) into a power saving mode. That can occur by way of a special signal transmitted wirelessly to the microphone. The connected device however may also be a wireless mixing desk which for example is used to process (mix) a plurality of microphone inputs and transmit that joint signal to the wireless receiver. Such situations occur when a plurality of audio engineers each having their own microphones are operating at one location. Here too the microphones connected to the mixing desk can in turn be in the form of wireless microphones so that the switching signal can also be transmitted to the individual microphones by way of the mixing desk. It is important at any event in that case that those devices do not completely switch off but only go into a sleep mode from which they can be “woken” again by a further signal so that they automatically resume their operation. In that respect, for the wireless receiver which plugs directly to the camera, it is certainly possible to achieve a power consumption of a few microamps in the “sleep phase”, but the transmitting devices connected by way of radio must keep their receiver ready for operation in order to be able to recognize the “wake signal”. In that state however the power consumption is to be limited to a few milliamps—a marked saving in relation to the normal operating situation.

The battery powered device (for example the receiver) however does not necessarily have to be connected to a mobile camera. For example it can also be plugged directly to the (for example XLR-) input jacks of a mixing desk. In that way, it is possible to save on the cabling to an external receiver together with that to the associated antenna and the receiver and the antenna itself. That gives a highly compact structure which for example is greatly valued in live music events.

### BRIEF DESCRIPTION OF THE DRAWINGS

FIG. 1 shows a wireless audio receiving unit according to the invention.

FIG. 2 shows a block circuit diagram of a wireless audio receiving unit according to the invention.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

FIG. 1 shows a wireless receiver 200 according to the invention. In this example it is fed by a replaceable accumulator 210 and fixed for example to a camera by way of a so-called XLR-plug 201. In this case the receiver is so small and light that the plug alone is sufficient as a mechanical connection; it also carries the weight of the receiver.

FIG. 2 show a block circuit diagram of a wireless receiver according to the invention. The wireless receiver 200 is fed by a battery or an accumulator 210 and has a plug 201 for example in the form of an XLR-plug. The camera receiver 200 can be connected to a camera or video camera 300 which has a plug or a jack 310 (for example in the form of an XLR-jack).

The jack has suitable contacts for the transmission of acoustic data 320 from the receiving unit and the phantom voltage 330 provided by the camera. In the camera receiver 200 a receiving unit 220 receives signals from a receiving antenna 400 and after demodulation and so forth passes them to the acoustic input 320 of the camera. The phantom voltage is monitored by the monitoring unit 230 for its presence within certain tolerances. When the phantom voltage falls below a predetermined value the monitoring unit 230 passes an item of information to the control unit 240 which optionally thereby causes for example the transmitting unit 250 to emit a corresponding switch-off signal by way of the transmitting antenna 500. That causes the further devices (typically at least one radio microphone) to switch into the sleep mode. The control unit 240 can then put the receiving unit 220 and the transmitting unit 250 into the power-saving sleep mode. In addition the monitoring unit 230 is responsible, when the phantom voltage exceeds a fixed limit value, to cause the control unit 240 to output corresponding control signals to the receiving unit 220 and the transmitting unit 250 in order to put same into the working mode again. In this case the control unit 240 also causes the transmitting unit 250 to send a suitable wake-up signal to the further devices, which also switches them into the working mode again.

It will be appreciated that the receiving and/or transmitting antenna can also be disposed within the receiver housing. A combination of both antennas to provide a single antenna unit is also possible.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. A method of controlling a wireless audio receiving unit having a plug configured to output wirelessly received audio signals and a power supply, comprising the steps:
placing the plug of the wireless audio receiving unit in a jack of a device that provides a phantom voltage or an external feed at the jack;
monitoring the phantom voltage or the external feed at the plug;
activating a power-saving sleep mode of the wireless audio receiving unit when no phantom voltage or external feed occurs at the plug; and
activating a working mode of the wireless audio receiving unit when the phantom voltage or the external feed is applied again.

2. A method as set forth in claim 1;
wherein the jack represents an audio input jack of a camera or video camera.

3. A method as set forth in claim 1;
wherein the wireless audio receiving unit is configured to switch a further device into a power-saving sleep mode, into the working mode again, or both, in dependence on the phantom voltage or the external feed.

4. A method as set forth in claim 1;
wherein the phantom feed is a 48 volt voltage and the plug represents an XLR-plug connection.

5. A method as set forth in claim 1;
wherein the device with the jack represents a camera, video camera or a mixing desk.

6. A wireless audio receiving unit comprising:
an interface configured to couple the wireless audio receiving unit to an external device;
a wireless receiving unit configured to wirelessly receive an audio signal transmitted from an external wireless microphone by way of a wireless path;
a monitoring unit coupled to the interface and configured to monitor whether there is a phantom voltage or an external feed at the interface; and
a control unit configured to activate or deactivate a power supply for the wireless receiving unit in dependence on whether the monitoring unit has detected a phantom voltage or an external feed at the interface.

7. A wireless audio receiving unit as set forth in claim 6;
wherein the control unit is configured to initiate deactivation of a power supply of a wireless transmitting unit when there is no phantom voltage or external feed at the interface.
